(19) United States
(12) Patent Application Publication
(10) Pub. No.: US 2024/0384427 A1
(43) Pub. Date: Nov. 21, 2024

(54) WATER ELECTROLYSIS DEVICE

(71) Applicant: TOYOTA JIDOSHA KABUSHIKI KAISHA, Toyota-shi (JP)

(72) Inventor: Haruyuki NAKANISHI, Nagoya-shi (JP)

(73) Assignee: TOYOTA JIDOSHA KABUSHIKI KAISHA, Toyota-shi (JP)

(21) Appl. No.: 18/429,979

(22) Filed: Feb. 1, 2024

(30) Foreign Application Priority Data
May 18, 2023 (JP) 2023-082601

(51) Int. Cl. C25B 15/027; C25B 1/04; C25B 9/17; C25B 9/70; C25B 15/08; H01M 10/30

(52) U.S. Cl. CPC C25B 15/027; C25B 1/04; C25B 9/17; C25B 15/08; C25B 9/70; H01M 10/30

(57) ABSTRACT

A water electrolysis device that causes a water electrolysis reaction to take out an H2 gas that includes a power source, a cell, at least one of a voltage sensor and a temperature sensor, a water level sensor, a water injection unit, and a control unit, and that performs control so as to increase the amount of the water injected when the water level of the electrolytic solution is lower than boundary lines between the positive electrode and the positive electrode terminal and between the negative electrode and the negative electrode terminal, and so as to decrease the amount of the water injected when the water level is higher than the boundary lines, when at least one of following (a) and (b) is met: (a) the cell voltage is more than 1.7 V; and (b) the temperature of the electrolytic solution is more than 50° C.

### CROSS-REFERENCE TO RELATED APPLICATION

This application claims priority to Japanese Patent Application No. 2023-082601 filed on May 18, 2023, incorporated herein by reference in its entirety.

### BACKGROUND

### 1. Technical Field

The present disclosure relates to a water electrolysis device.

### 2. Description of Related Art

In recent years, there has been an increasing demand for a hydrogen (H₂) gas as an energy source for fuel cell electric vehicles and power generation, and studies on methods of producing an H₂ gas have also been conducted. Examples of a method of producing an H₂ gas include a method of decomposing water (H₂O) into a hydrogen (H₂) gas and an oxygen (O₂) gas by water electrolysis.

For example, Japanese Unexamined Patent Application Publication No. 2021-17628 (JP 2021-17628 A) discloses a hydrogen gas production device including a water electrolysis cell and a power source, in which: the water electrolysis cell includes a first electrode, a second electrode, and an alkali aqueous solution; the first electrode and the second electrode are each in contact with the alkali aqueous solution; the first electrode and the second electrode are spaced apart from each other; the first electrode includes a hydrogen storing alloy; the hydrogen storing alloy has an equilibrium dissociation pressure of 0.2 MPa or more at 20° C.; the first electrode and the second electrode are each connected to the power source, the power source applies a voltage between the first electrode and the second electrode such that the first electrode serves as a negative electrode and the second electrode serves as a positive electrode; and a hydrogen gas is generated at the first electrode by electrolysis of the alkaline aqueous solution.

Meanwhile, Japanese Unexamined Patent Application Publication (Translation of PCT Application) No. 2017-534764 (JP 2017-534764 A) discloses a system that generates a hydrogen gas from an aqueous solution, including: a first compartment including a first working electrode and a first redox active electrode; and a second compartment including a second working electrode and a second redox active electrode, the first compartment and the second compartment each having an inlet configured to receive an aqueous solution, in which: the first working electrode is connectable to a power source and is configured to provide a reduction of water in the aqueous solution in response to a voltage applied by the power source, thereby generating a hydrogen gas and hydroxide ions; the second working electrode is connectable to the power source and is configured to provide an oxidation of hydroxide ions in response to a voltage applied by the power source, thereby generating an oxygen gas and water; the second redox active electrode and the first redox active electrode are electrically connectable to each other, and capable of reversibly undergoing an oxidation in the presence of hydroxide ions and undergoing a reduction in the presence of water, respectively, thereby producing hydroxide ions; and the first compartment and the second compartment are separated from each other.

### SUMMARY

When water is consumed by the water electrolysis reaction and the water level of the electrolytic solution decreases, the positive electrode and the negative electrode immersed in the electrolytic solution are exposed, and further, when voltage is continuously applied in this state, heat generation occurs. In particular, when the electrolytic solution is exhausted and the positive electrode and the negative electrode are fully exposed, strong heat generation may occur and the cell may become high in temperature. Therefore, it is expected that the amount of the electrolytic solution is controlled so as to be larger. However, when the water level of the electrolytic solution increases, the positive electrode terminal connected to the positive electrode and the negative electrode terminal connected to the negative electrode are also immersed in the electrolytic solution, and a reaction other than the water electrolytic reaction occurs on the surface where the terminals are immersed in the electrolytic solution. As a result, electric charges are consumed in the other reaction, and the generation efficiency of H₂ gases is reduced.

In view of the above, it is an object of the present disclosure to provide a water electrolysis device capable of suppressing a cell becoming hot because of heat generation and achieving a high H₂ generation efficiency.

Means for addressing the above issue include the following aspects.
<1> A water electrolysis device that causes a water electrolysis reaction to take out an H₂ gas, the water electrolysis device including: a power source; a cell including a positive electrode, a negative electrode, a positive electrode terminal connected to the power source and the positive electrode, a negative electrode terminal connected to the power source and the negative electrode, and an electrolytic solution containing water; at least one of a voltage sensor that detects a voltage applied to the cell and a temperature sensor that detects a temperature of the electrolytic solution; a water level sensor that detects a water level of the electrolytic solution; a water injection unit that injects the water into the electrolytic solution; and a control unit that controls an amount of the water injected from the water injection unit, in which the control unit performs control so as to increase the amount of the water injected from the water injection unit when the water level of the electrolytic solution detected by the water level sensor is lower than a boundary line between the positive electrode and the positive electrode terminal and a boundary line between the negative electrode and the negative electrode terminal, and so as to decrease the amount of the water injected from the water injection unit when the water level of the electrolytic solution is higher than the boundary lines, when at least one of following (a) and (b) is met:
(a) the voltage detected by the voltage sensor is more than 1.7 V; and
(b) the temperature of the electrolytic solution detected by the temperature sensor is more than 50° C.
<2> The water electrolysis device according to <1>, in which the cell is a nickel-metal hydride storage battery.
<3> The water electrolysis device according to <2>, in which the nickel-metal hydride storage battery is a used storage battery.
<4> The water electrolysis device according to any one of <1> to <3>, in which the amount of the water injected is controlled by the control unit such that the water level of the electrolytic solution becomes 80% or more when the water level of the electrolytic solution coinciding with the boundary lines is defined as 100%.
<5> The water electrolysis device according to any one of <1> to <4>, in which, when the water is injected into the electrolytic solution from the water injection unit, the water is injected so as not to be in contact with the positive electrode terminal and the negative electrode terminal.

According to the present disclosure, it is possible to provide a water electrolysis device capable of suppressing a cell becoming hot because of heat generation and achieving a high H₂ generation efficiency.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view illustrating a water electrolysis device according to an embodiment of the present disclosure;

FIG. 2 is a schematic cross-sectional view showing a state where the water level of the electrolytic solution is lowered in FIG. 1; and

FIG. 3 is a schematic cross-sectional view showing a state where the water level of the electrolytic solution is raised in FIG. 1.

### DETAILED DESCRIPTION OF EMBODIMENTS

Hereinafter, a water electrolysis device according to the present disclosure will be described in detail with reference to the drawings. Each drawing shown below is schematically shown, and the size and shape of each part are appropriately exaggerated for easy understanding. In addition, in the present specification, when expressing a mode in which another member is disposed with respect to a certain member, when simply referred to as “on” or “below”, unless otherwise specified, it includes both a case in which another member is disposed directly above or directly below a certain member so as to be in contact with the certain member, and a case in which another member is disposed above or below a certain member via another member.

### Water Electrolysis Device

A water electrolysis device according to an embodiment of the present disclosure is an apparatus that takes out H₂ gases by causing a water electrolysis reaction. Further, O₂ gases can also be extracted.

The water electrolysis device includes a power source and a cell. The cell includes a positive electrode, a negative electrode, a positive electrode terminal connected to the power source and the positive electrode, a negative electrode terminal connected to the power source and the negative electrode, and an electrolytic solution containing water. Further, the water electrolysis device includes at least one of a voltage sensor for detecting a voltage applied to the cell and a temperature sensor for detecting a temperature of the electrolytic solution, a water level sensor for detecting a water level of the electrolytic solution, a water injection unit for injecting water into the electrolytic solution, and a control unit for controlling an injection amount of water from the water injection unit. Then, when at least one of the following (a) and (b) is satisfied, the water electrolysis device controls the control unit to increase the amount of water injected from the water injection unit when the water level of the electrolytic solution detected by the water level sensor is lower than the boundary line between the positive electrode and the positive electrode terminal and the boundary line between the negative electrode and the negative electrode terminal, and decrease the amount of water injected from the water injection unit when the water level of the electrolytic solution is higher than the boundary line.
(a) When the voltage detected by the voltage sensor exceeds 1.7 V
(b) When the temperature of the electrolytic solution detected by the temperature sensor exceeds 50° C.

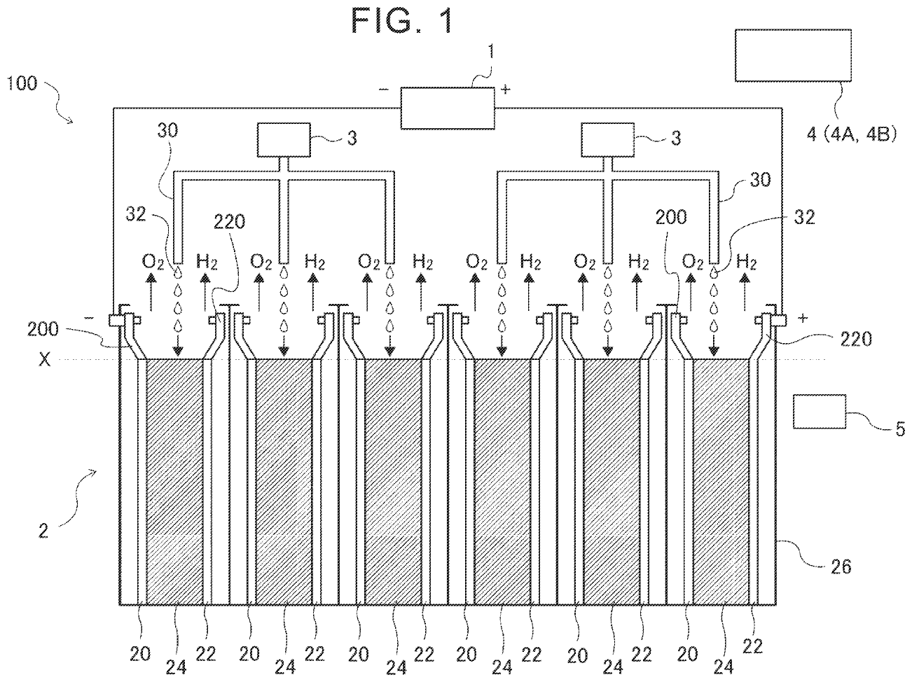

An embodiment of a water electrolysis device according to the present disclosure will be described with reference to FIG. 1. FIG. 1 is a schematic perspective view illustrating a water electrolysis device according to an embodiment of the present disclosure. The water electrolysis device 100 shown in FIG. 1 includes a power source 1 and a cell 2. In the cell 2, an electrolytic solution 24 including a positive electrode 20, a negative electrode 22, a positive electrode terminal 200 connected to the power source 1 and the positive electrode 20, a negative electrode terminal 220 connected to the power source 1 and the negative electrode 22, and water (H₂O) 32 is accommodated in the housing 26. Note that the cell 2 shown in FIG. 1 is a six-row cell in which six housings 26 containing the positive electrode 20, the negative electrode 22, the positive electrode terminal 200, the negative electrode terminal 220, and the electrolytic solution 24 are arranged. The positive electrode terminal 200 is disposed above the positive electrode 20 in the gravitational direction, and the negative electrode terminal 220 is disposed above the negative electrode 22 in the gravitational direction. In the cell 2 shown in FIG. 1, the positive electrode 20 and the negative electrode 22 are immersed in the electrolytic solution 24, while the positive electrode terminal 200 and the negative electrode terminal 220 are not immersed in the electrolytic solution 24, that is, the water level of the electrolytic solution 24 is adjusted to a height equal to the boundary line X between the positive electrode 20, the positive electrode terminal 200, the negative electrode 22, and the negative electrode terminal 220.

The water electrolysis device 100 includes a voltage monitoring device 4A that detects a voltage applied to the cell 2 by a voltage sensor (not shown) and monitors the detected voltage. Instead of the voltage sensor and the voltage monitoring device 4A, the water electrolysis device 100 may include a temperature monitoring device 4B that detects the temperature of the electrolytic solution 24 in the cell 2 by a temperature sensor (not shown) and monitors the detected temperature. The voltage sensor and the voltage monitoring device 4A sense the voltage across the cell 2 regulated by the power source 1 (and optionally a resistor) and monitor the voltage. The temperature sensor and the temperature monitoring device 4B detect the temperature of the electrolytic solution 24 in the respective housings 26 of the cell 2 and monitor the temperature.

The water electrolysis device 100 includes a water level sensor 5 for detecting a water level of the electrolytic solution 24, a water injection pipe 30 as a water injection unit for injecting the water 32 into the electrolytic solution 24, and a control device 3 as a control unit for controlling an injection amount of water from the water injection pipe 30. The water level sensor 5 is a sensor that detects the water level of the electrolytic solution 24 in each housing 26 of the cell 2.

The power source 1 incorporates a function of an electronic load. However, the power source 1 in which the function of the electronic load is not built may be used, and in this case, the water electrolysis device 100 may further include a device (for example, a resistor, not shown) having the function of the electronic load. In the water electrolysis device 100, the voltage is adjusted to increase and decrease by the power source 1 (or a resistor as needed), and the voltage is held at the required voltage, so that a water electrolysis reaction is generated in the water in the electrolysis solution, and H₂ gases can be extracted. It is also possible to collect O₂ gases generated by the water electrolysis. The reaction formulas for the positive electrode and the negative electrode are shown below.

(Positive electrode) OH⁻→½H₂O+¼O₂+e⁻

(Anode) H₂O+e⁻→½H₂+OH⁻

In the water electrolysis device 100, a nickel-metal hydride storage battery is used as the cell 2. That is, a nickel-metal hydride storage battery in which six housings 26 containing the positive electrode 20, the negative electrode 22, the positive electrode terminal 200, the negative electrode terminal 220, and the electrolytic solution 24 are arranged is used as the cell 2. The nickel-metal hydride battery may be a used nickel-metal hydride battery. Note that “used” means that the charge capacity is lower than that of the battery immediately after manufacturing.

Here, the water level of the electrolytic solution 24 will be described.

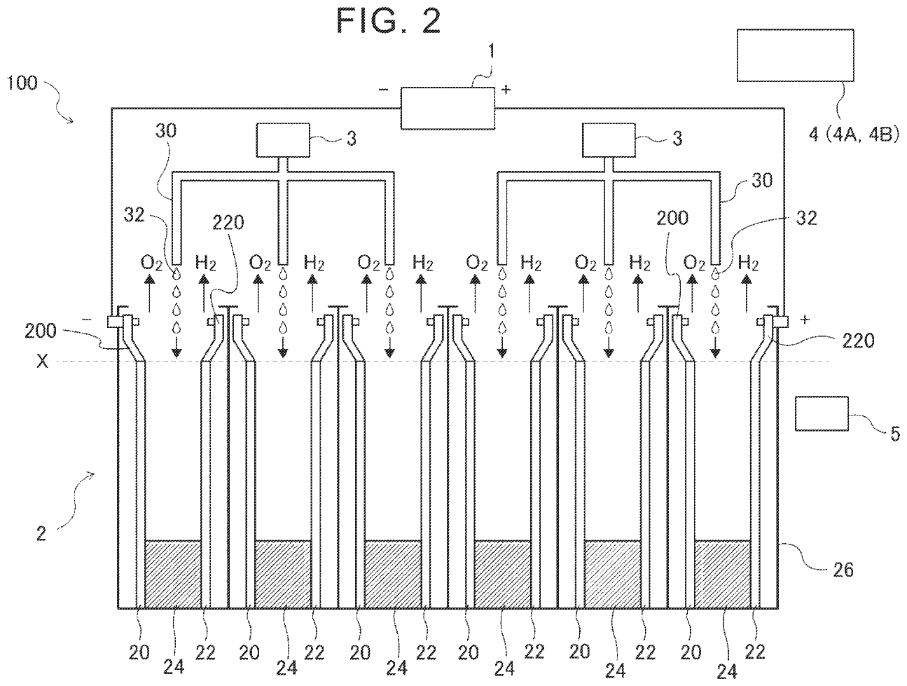

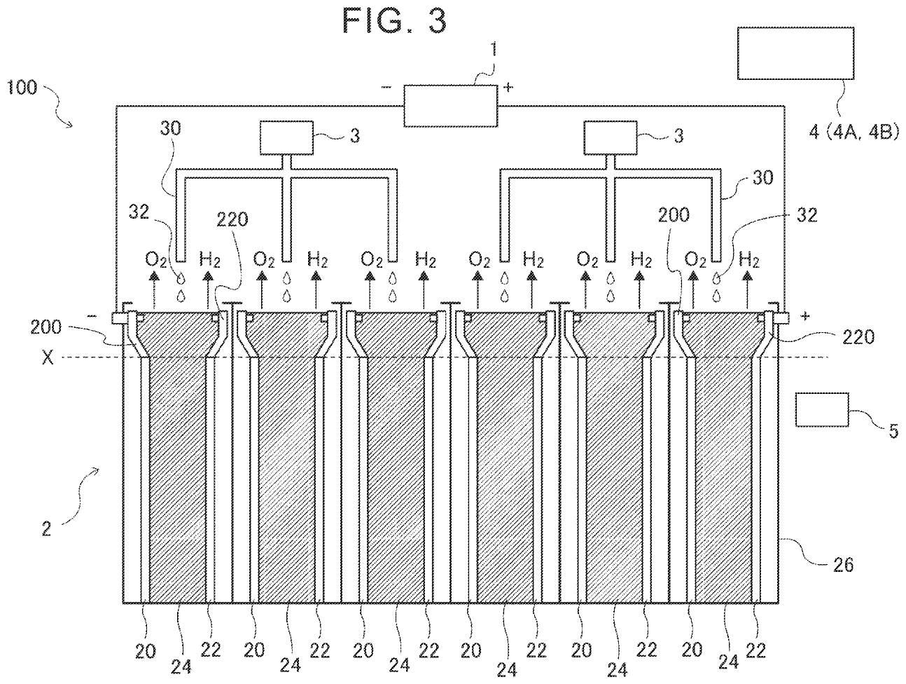

The water level of the electrolytic solution 24 means the height of the liquid level of the electrolytic solution 24 in the cell 2. Therefore, in FIG. 1, the water level of the electrolytic solution 24 is adjusted to a height equal to the boundary line X between the positive electrode 20, the positive electrode terminal 200, the negative electrode 22, and the negative electrode terminal 220, but when the water level of the electrolytic solution 24 becomes low as shown in FIG. 2, part of the positive electrode 20 and the negative electrode 22 is exposed from the electrolytic solution 24. On the other hand, when the water level of the electrolytic solution 24 becomes high as shown in FIG. 3, the positive electrode terminal 200 and the negative electrode terminal 220 are also immersed in the electrolytic solution 24.

When the water electrolysis reaction is performed in the water electrolysis device 100 shown in FIG. 1, the amount of the electrolytic solution 24 is reduced because the water in the electrolytic solution 24 is consumed by the reaction. On the other hand, water 32 is injected into the electrolytic solution 24 from the control device 3 through the water injection pipe 30, and the amount of the electrolytic solution 24 increases. If the amount of water consumed by the water electrolysis reaction is equal to the amount of water injected into the water 32, the water level of the electrolytic solution 24 is kept constant, and if the amount of water consumed by the water electrolysis reaction is larger, the water level of the electrolytic solution 24 is lowered, and if the amount of water injected into the water 32 is larger, the water level of the electrolytic solution 24 is raised.

However, if the water level of the electrolytic solution 24 continues to decrease and the electrolytic solution 24 disappears (that is, the liquid is dead), and the voltage is continued to be applied in a state where the positive electrode 20 and the negative electrode 22 are exposed, there is a possibility that heat generation occurs and the temperature becomes high. Therefore, it is expected that the amount of the electrolytic solution 24 is controlled to be larger in order to suppress the elimination of the electrolytic solution 24 (liquid wilting). However, when the amount of the electrolytic solution 24 increases and the water level of the electrolytic solution 24 increases, the positive electrode terminal 200 and the negative electrode terminal 220 are also immersed in the electrolytic solution 24. When a voltage is applied while the positive electrode terminal 200 and the negative electrode terminal 220 are immersed in the electrolytic solution 24, a reaction other than a water electrolytic reaction occurs on the surface of the terminal, that is, electric charges are consumed in another reaction, and therefore, generation efficiency of H₂ gases is reduced.

In the present disclosure, as described above, a nickel-metal hydride storage battery can be used as the cell, and in particular, a used nickel-metal hydride storage battery can be used. In the future, it is expected that a large amount of used nickel-metal hydride storage batteries mounted on battery electric vehicle (BEV), plug-in hybrid electric vehicle (PHEV), hybrid electric vehicle (HEV) and the like will be discharged, and it is desirable to convert such used nickel-metal hydride storage batteries to a water electrolysis device in a form as close to reuse as possible. However, in the case where a used nickel-hydrogen storage battery is used in a cell of a water electrolysis device, a method is conceivable in which the amount of the electrolytic solution is controlled so as to be larger in order to suppress the depletion of the electrolytic solution. However, as described above, in such cases, the positive electrode terminal and the negative electrode terminal are immersed in the electrolytic solution, and other reactions other than the aqueous electrolysis reaction occur, so that the generation efficiency of H₂ gases is reduced.

For the above reasons, it is preferable to continue to adjust the water level of the electrolytic solution so as to be a height near the boundary line between the positive electrode, the positive electrode terminal, and the negative electrode and the negative electrode terminal.

Therefore, in the water electrolysis device according to the embodiment of the present disclosure, the control unit performs control so as to increase the amount of the water injected from the water injection unit when the water level of the electrolytic solution detected by the water level sensor is lower than a boundary line between the positive electrode and the positive electrode terminal and a boundary line between the negative electrode and the negative electrode terminal, and so as to decrease the amount of the water injected from the water injection unit when the water level of the electrolytic solution is higher than the boundary lines, when at least one of following (a) and (b) is met:
(a) When the voltage detected by the voltage sensor exceeds 1.7 V
(b) When the temperature of the electrolytic solution detected by the temperature sensor exceeds 50° C.

First, the relationship between the water level of the electrolytic solution, the voltage of the cell, and the temperature of the electrolytic solution will be described. As shown in FIG. 1, when the water level of the electrolytic solution is lower than in the case where the water level of the electrolytic solution is adjusted to a height equal to the boundary line between the positive electrode, the positive electrode terminal, and the negative electrode and the negative electrode terminal, part of the positive electrode and the negative electrode is exposed from the electrolytic solution. When the voltage is continuously applied in a state where the positive electrode and the negative electrode are exposed, heat is generated at the exposed portions of the positive electrode and the negative electrode, and the temperature of the electrolytic solution increases, and the voltage applied to the cell increases. On the other hand, when the water level of the electrolytic solution is higher than that in the case where the water level is adjusted to be equal to the boundary line, the positive electrode terminal and the negative electrode terminal are also immersed in the electrolytic solution. When the voltage is continuously applied in this state, leakage occurs at the immersed portions of the positive electrode terminal and the negative electrode terminal, the voltage applied to the cell increases, and the temperature of the electrolytic solution increases. From the above points, it has been found that by detecting at least one of an increase in the voltage of the cell and an increase in the temperature of the electrolytic solution, the change in the water level of the electrolytic solution can be used as an index.

In the present disclosure, when (a) is satisfied, the voltage of the cell is detected by a voltage sensor. When the cell voltage exceeds 1.7 V value, the amount of water injected by the control unit is controlled. Specifically, when the voltage of the cell exceeds 1.7 V, when the water level of the electrolytic solution detected by the water level sensor is lower than the boundary line between the positive electrode and the positive electrode terminal and the boundary line between the negative electrode and the negative electrode terminal, the control unit controls to increase the injection amount of water from the water injection unit, while when the water level of the electrolytic solution detected by the water level sensor is higher than the boundary line, the control unit controls to reduce the injection amount of water from the water injection unit.

When (b) is satisfied, the temperature of the electrolytic solution is detected by a temperature sensor. When the temperature of the electrolytic solution exceeds 50° C., the amount of water injected by the control unit is controlled. Specifically, when the temperature of the electrolytic solution exceeds 50° C., when the water level of the electrolytic solution detected by the water level sensor is lower than the boundary line between the positive electrode and the positive electrode terminal and the boundary line between the negative electrode and the negative electrode terminal, the control unit controls to increase the amount of water injected from the water injection unit, while when the water level of the electrolytic solution detected by the water level sensor is higher than the boundary line, the control unit controls to reduce the amount of water injected from the water injection unit.

Thus, by controlling the injection amount of water when at least one of (a) and (b) is satisfied, the water level of the electrolytic solution can be continuously adjusted so as to be in the vicinity of the boundary line between the positive electrode, the positive electrode terminal, and the negative electrode and the negative electrode terminal. As a result, it is possible to prevent the electrolytic solution from becoming exothermic (that is, the liquid is dead) and to prevent the electrolytic solution from becoming exothermic to a high temperature, and to prevent the electric charges from being consumed in other reactions other than the water electrolytic reaction, so that the generation efficiency of H₂ gases can be improved.

Incidentally, when satisfying the above (a), from the viewpoint of achieving the higher generation efficiency of H₂ gases and further suppressing the generation of heat generation and the cell becomes high temperature, it is preferable to control the injection amount of water by the control unit when the voltage of the cell detected by the voltage sensor becomes higher than 1.6 V by the above method, it is more preferable to control the injection amount of water by the control unit when the voltage of the cell becomes higher than 1.5 V by the above method. In addition, when the above (b) is satisfied, it is preferable to control the amount of water injected by the control unit when the temperature of the electrolytic solution detected by the temperature sensor exceeds 30° C., from the viewpoint of further suppressing generation of heat and raising the temperature of the cell to a high temperature and achieving higher generation efficiency of H₂ gases.

In the case where both of (a) and (b) are satisfied, it is preferable to control the amount of water injected by the control unit so that the water level of the electrolytic solution becomes 80% or higher in the case where the water level of the electrolytic solution coincides with the boundary line between the positive electrode, the positive electrode terminal, and the negative electrode and the negative electrode terminal is 100%, from the viewpoint of further suppressing the occurrence of heat generation and the cell from becoming high temperature.

Further, when water is injected into the electrolytic solution from the water injection unit (for example, the water injection pipe 30 shown in FIG. 1), from the viewpoint of suppressing the occurrence of electric leakage, it is preferable that the injection is performed so that the water does not come into contact with the positive electrode terminal and the negative electrode terminal.

In FIG. 1, the cell 2 is illustrated in which the positive electrode 20, the negative electrode 22, the positive electrode terminal 200, and the negative electrode terminal 220 are housed in one housing 26 one by one, respectively, but the aspect of the cell is not limited thereto.

For example, the positive electrode and the negative electrode may be accommodated in separate housings, and the housings may be immersed in the same electrolytic solution. That is, the cell may be constituted by the positive electrode and the positive electrode terminal being accommodated in the first housing, the negative electrode and the negative electrode terminal being accommodated in the second housing, and the first housing and the second housing being immersed in the same electrolytic solution. In this case, since the oxygen gas is generated from the first housing having the positive electrode and the hydrogen gas is generated from the second housing having the negative electrode, the hydrogen gas and the oxygen gas can be easily taken out separately. Note that a nickel-hydrogen storage battery can be used for the first housing and the second housing, and a used nickel-hydrogen storage battery can also be used.

In the present disclosure, a used nickel-metal hydride storage battery can be applied to the cell, and the nickel-metal hydride storage battery can be reused to extract H₂ gas and O₂ gas.

Here, generation of hydrogen gas in the water electrolysis device according to the embodiment of the present disclosure was confirmed by an experiment.

### Preparation of Water Electrolysis Device

A water electrolysis device having the same configuration as the water electrolysis device 100 shown in FIG. 1 and using the following as a cell and an electrolysis solution was prepared.
Cell: A six series of cells which are used nickel hydride livestock batteries, each of which houses a positive electrode, a negative electrode, a positive electrode terminal, and a negative electrode terminal, and that arrange six housings containing an electrolytic solution Electrolytic solution: Potassium Hydroxide (KOHaq, pH15), wherein water (H₂O) is contained in an amount of 64%
Note that each positive electrode terminal and each negative electrode terminal in six cells in which six housings were arranged were connected in series to a power source (a power source with a built-in function of an electronic load).

In this water electrolysis device, while water was injected into the electrolytic solution from the water injection pipe, the voltage applied to the cell was adjusted by a power source so as to be a voltage at which a water electrolytic reaction occurs.

### EXAMPLE 1-1

When a water electrolysis reaction is generated by a water electrolysis device, a voltage sensor detects a voltage of a cell, and a voltage monitoring device monitors the detected voltage, and when a voltage of the cell exceeds a 1.7 V, a control device controls an injection amount of water. Specifically, when the cell voltage exceeds 1.7 V value, when the water level of the electrolytic solution detected by the water level sensor is lower than the boundary line between the positive electrode, the positive electrode terminal, and the negative electrode and the negative electrode terminal, the control device controls to increase the amount of water injected from the water injection pipe, while when the water level of the electrolytic solution detected by the water level sensor is higher than the boundary line, the control device controls to reduce the amount of water injected from the water injection pipe.

The “temperature of the cell” was measured after 10 minutes, 20 minutes, 30 minutes, and 40 minutes, and the “generation efficiency of hydrogen gas” was measured after 40 minutes. The results are shown in Table 1.

### EXAMPLE 1-2

The water electrolysis reaction was generated in the same manner as in Example 1-1, except that when the water electrolysis reaction was caused by the water electrolysis device, the voltage of the cell was detected by the voltage sensor, and when the voltage of the cell became higher than 1.6 V, the water injection rate by the control device was controlled. The results are shown in Table 1.

### EXAMPLE 1-3

The water electrolysis reaction was generated in the same manner as in Example 1-1, except that when the water electrolysis reaction was caused by the water electrolysis device, the voltage of the cell was detected by the voltage sensor, and when the voltage of the cell became higher than 1.5 V, the water injection rate by the control device was controlled. The results are shown in Table 1.

### EXAMPLE 2-1

When a water electrolysis reaction was caused by a water electrolysis device, the temperature of the electrolysis solution was detected by a temperature sensor, and the detected temperature was monitored by a temperature monitoring apparatus, and when the temperature of the electrolysis solution became more than 50° C., the injection amount of water by the control device was controlled. Specifically, when the temperature of the electrolytic solution exceeds 50° C., when the water level of the electrolytic solution detected by the water level sensor is lower than the boundary line between the positive electrode, the positive electrode terminal, and the negative electrode and the negative electrode terminal, the control device controls to increase the amount of water injected from the water injection pipe, while when the water level of the electrolytic solution detected by the water level sensor is higher than the boundary line, the control device controls to reduce the amount of water injected from the water injection pipe.

As in Example 1-1, the “cell temperature” after 10 minutes, 20 minutes, 30 minutes, and 40 minutes and the “hydrogen gas generation efficiency” after 40 minutes were measured. The results are shown in Table 1.

### EXAMPLE 2-2

A water electrolysis reaction was generated in the same manner as in Example 2-1, except that the temperature of the electrolytic solution was detected by a temperature sensor when the water electrolysis reaction was caused by the water electrolysis device, and the injection amount of water by the control device was controlled when the temperature of the electrolytic solution became higher than 30° C. The results are shown in Table 1.

### COMPARATIVE EXAMPLE 1

The water electrolysis reaction was generated in the same manner as in Example 1-1, except that when the water electrolysis reaction was caused by the water electrolysis device, the voltage of the cell was detected by the voltage sensor, and when the voltage of the cell became higher than 2.0 V, the water injection rate by the control device was controlled. The results are shown in Table 1.

### COMPARATIVE EXAMPLE 2

A water electrolysis reaction was generated in the same manner as in Example 2-1, except that the temperature of the electrolytic solution was detected by a temperature sensor when the water electrolysis reaction was caused by the water electrolysis device, and the injection amount of water by the control device was controlled when the temperature of the electrolytic solution became higher than 70° C. The results are shown in Table 1.

TABLE 1

| | | | | | | Hydrogen |
|---|---|---|---|---|---|---|
| | | | | | | gas |
| | | Cell temperature [° C.] | | | | generation |
| | | 10 | 20 | 30 | 40 | efficiency |
| | Monitoring | minutes | minutes | minutes | minutes | [%] |
| Example 1-1 | Cell Voltage | 43.2 | 44.9 | 46.6 | 50.1 | 87.1 |
| | (over 1.7 V) | | | | | |
| Example 1-2 | Cell Voltage | 18 | 19.4 | 29 | 32.8 | 92.6 |
| | (over 1.6 V) | | | | | |
| Example 1-3 | Cell Voltage | 17.9 | 17.5 | 17.7 | 17.7 | 98.7 |
| | (over 1.5 V) | | | | | |
| Example 2-1 | Temperature | 51 | 51 | 52 | 51 | 70~75 |
| | of electrolytic | | | | | |
| | solution | | | | | |
| | (50° C.) | | | | | |
| Example 2-2 | Temperature | 30 | 28 | 29 | 28 | 80~85 |
| | of electrolytic | | | | | |
| | solution | | | | | |
| | (30° C.) | | | | | |
| Comparative | Cell Voltage | 52 | 55 | 65 | 80 | 60 or less |
| Example 1 | (over 2.0 V) | | | | | |
| Comparative | Temperature | 75 | Stopping | Stopping | Stopping | — |
| Example 2 | of electrolytic | | boiling | boiling | boiling | |
| | solution (over | | | | | |
| | 70° C.) | | | | | |

As shown in Examples and Comparative Examples in Table 1, it can be seen that, when detecting the voltage of the cell or detecting the temperature of the electrolytic solution, and satisfying at least one of (a) and (b) described above, by controlling the amount of water injected by the control device, the cell is suppressed from becoming high-temperature due to heat generation, and a high H₂ gas generation efficiency can be achieved.

In the case where the water level of the electrolytic solution is maintained in a state higher than the boundary line simply without performing both the detection of the voltage of the cell and the detection of the temperature of the electrolytic solution, and the injection amount of the water from the water injection pipe is set so that the water level is maintained at 120% when, for example, the case where the water level of the electrolytic solution coincides with the boundary line is set to 100%, it is presumed that the generation efficiency of the hydrogen gas is further deteriorated as compared with Comparative Example 1. In addition, in a case where neither the detection of the voltage of the cell nor the detection of the temperature of the electrolytic solution is performed but the water level of the electrolytic solution is simply kept lower than the boundary line, for example, in a case where the water level of the electrolytic solution coincides with the boundary line is set to 100%, the water level of the electrolytic solution is maintained at a water level of 50%, and in a case where the injection amount of water from the water injection pipe is set, it is presumed that the temperature of the cell rapidly rises and the electrolytic solution boils and eventually the liquid is dead.

What is claimed is:

1. A water electrolysis device that causes a water electrolysis reaction to take out an H₂ gas, the water electrolysis device comprising:
a power source;
a cell including a positive electrode, a negative electrode, a positive electrode terminal connected to the power source and the positive electrode, a negative electrode terminal connected to the power source and the negative electrode, and an electrolytic solution containing water;
at least one of a voltage sensor that detects a voltage applied to the cell and a temperature sensor that detects a temperature of the electrolytic solution;
a water level sensor that detects a water level of the electrolytic solution;
a water injection unit that injects the water into the electrolytic solution; and
a control unit that controls an amount of the water injected from the water injection unit, in which
the control unit performs control so as to increase the amount of the water injected from the water injection unit when the water level of the electrolytic solution detected by the water level sensor is lower than a boundary line between the positive electrode and the positive electrode terminal and a boundary line between the negative electrode and the negative electrode terminal, and so as to decrease the amount of the water injected from the water injection unit when the water level of the electrolytic solution is higher than the boundary lines, when at least one of following (a) and (b) is met:
(a) the voltage detected by the voltage sensor is more than 1.7 V; and
(b) the temperature of the electrolytic solution detected by the temperature sensor is more than 50° C.

2. The water electrolysis device according to claim 1, wherein the cell is a nickel-metal hydride storage battery.

3. The water electrolysis device according to claim 2, wherein the nickel-metal hydride storage battery is a used storage battery.

4. The water electrolysis device according to claim 1, wherein the amount of the water injected is controlled by the control unit such that the water level of the electrolytic solution becomes 80% or more when the water level of the electrolytic solution coinciding with the boundary lines is defined as 100%.

5. The water electrolysis device according to claim 1, wherein, when the water is injected into the electrolytic solution from the water injection unit, the water is injected so as not to be in contact with the positive electrode terminal and the negative electrode terminal.
